(19) United States
(12) Patent Application Publication
(10) Pub. No.: US 2011/0280239 A1
(43) Pub. Date: Nov. 17, 2011

(54) COMMUNICATION SESSION HAND-OFF METHOD AND COMMUNICATION DEVICE

(75) Inventors: Chao-ping TUNG, Flower Mound, TX (US); Feng MO, Lewisville, TX (US)

(73) Assignee: MURATA MANUFACTURING CO., LTD., Nagaokakyo-shi (JP)

(21) Appl. No.: 12/779,088

(22) Filed: May 13, 2010

(51) Int. Cl. H04L 12/66; G06F 15/16

(52) U.S. Cl. 370/352; 709/227

(57) ABSTRACT

A communication session hand-off method of a communication device includes establishing a first communication session over a first network between a first communication interface of the communication device and a communication interface of another communication device, monitoring a predetermined condition of the communication device by the communication device, and based upon the predetermined condition, sending a request by the communication device to the another communication device for the another communication device to establish a second communication session over a second network between a second communication interface of the communication device and the communication interface of the another communication device.

### BACKGROUND OF THE INVENTION

1. Field of the Invention

The present invention relates to a method for automatic hand-off, or switching, between two different communication sessions using different communication protocols. More specifically, the present invention relates to a handset that can automatically hand-off between different communication sessions.

2. Description of the Related Art

When communicating on a mobile wireless communication device, it is often necessary to hand-off, or switch, from a first communication session with a first communication protocol to a second communication session with a second communication protocol. These hand-offs can occur, for example, as a wireless mobile device moves further away from a first access point used for the first communication session and as the signal strength between the first access point and the wireless mobile device decreases. The measurement of the signal strength is monitored by a network-based hand-off controller external to the wireless mobile device that decides when to change between the first and second communication sessions. As the signal strength between the first access point and the wireless mobile device decreases, it becomes necessary to hand-off to the second access point to maintain communications. The network-based hand-off controller only works for hand-offs between communication sessions that are operated by the same service provider or that use the same communication protocol.

Some wireless mobile devices include a plurality of communication interfaces for communicating over different communication systems with different communication protocols. For example, some cellular telephones include both a GSM communication interface to communicate over relatively long distances (e.g. in a WAN network) using the GSM protocol and a Wi-Fi communication interface for communicating over shorter distances (e.g. in a WLAN network) using the Wi-Fi protocol. It is often desirable to communicate over the Wi-Fi network rather than the GSM network because transmitting data over the Wi-Fi network is typically cheaper than transmitting data over the GSM network. However, because Wi-Fi networks have very limited transmission ranges, it is usually not possible to communicate exclusively through Wi-Fi.

Some wireless mobile devices perform hand-offs from a first communication session using Wi-Fi communication to a second communication session using GSM when the user of a wireless mobile device leaves the signal coverage area of the Wi-Fi network. Hand-offs between communication sessions with different communications protocols, e.g., Wi-Fi to GSM or GSM to Wi-Fi, require more steps than hand-offs with the same communication protocol, e.g., Wi-Fi to Wi-Fi or GSM to GSM.

Accordingly, there is a need in the art for a system that can automatically perform hand-offs between different communication sessions by responding to a change in a predetermined condition without requiring the use of any network-based controllers or the use of proprietary signaling methods.

### SUMMARY OF THE INVENTION

To overcome the problems described above, preferred embodiments of the present invention provide communication session hand-off methods of a communication device and communication devices that can automatically perform hand-offs between different communication sessions by responding to a change in a predetermined condition without requiring the use of any network-based controllers or the use of proprietary signaling methods.

According to a preferred embodiment of the present invention, a communication session hand-off method of a communication device includes establishing a first communication session over a first network between a first communication interface of the communication device and a communication interface of another communication device, monitoring a predetermined condition of the communication device by the communication device, and based upon the predetermined condition, sending a request by the communication device to the another communication device for the another communication device to establish a second communication session over a second network between a second communication interface of the communication device and the communication interface of the another communication device.

The another communication device is preferably an IP telephone. The first network is preferably one of a cellular network, a POTS network, and an IP based network, and the second network is preferably one of a cellular network, a POTS network, and an IP based network. The predetermined condition is preferably one or more of the following: magnitude of a signal strength of the first communication session, detection of a preferred network, quality of the first communication session, user generated command, and charge level of a battery.

According to a preferred embodiment of the present invention, a communication session hand-off method of a communication device includes establishing a first communication session over a telephone network through a telephone exchange between a first communication interface of the communication device and a communication interface of another communication device, establishing a second communication session through a telephone exchange from a second communication interface of the first communication device to the first communication interface of the first communication device, monitoring a predetermined condition, and based upon the predetermined condition, establishing a third communication session by connecting the first communication session and the second communication session such that the third communication session is established between the second communication interface of the first communication device and the communication interface of the another communication device.

The another communication device is preferably an IP telephone. The telephone network is preferably one of a cellular network and POTS network. Before the step of establishing the third communication session, the first communication session is preferably placed on hold. The step of establishing a third communication session is preferably performed by explicit call transfer. The predetermined condition is preferably one or more of the following: magnitude of a signal strength of the first communication session, detection of a preferred network, quality of the first communication session, user generated command, and charge level of a battery.

According to a preferred embodiment of the present invention, a communication device includes a first communication interface, a second communication interface, a monitoring device arranged to monitor a predetermined condition of the communication device, and a controller arranged to establish a first communication session over a first network between the first communication interface of the first communication device and a communication interface of another communication device and arranged to, based upon the predetermined condition, send a request by the communication device to the another communication device for the another communication device to establish a second communication session over a second network between the second communication interface of the communication device and the communication interface of the another communication device.

The first network is preferably one of a cellular network, a POTS network, and an IP based network, and the second network is preferably one of a cellular network, a POTS network, and an IP based network. The predetermined condition is preferably one or more of the following: magnitude of a signal strength of the first communication session, detection of a preferred network, quality of the first communication session, user generated command, and charge level of a battery.

According to a preferred embodiment of the present invention a communication device includes a first communication interface, a second communication interface, a monitoring device arranged to monitor a predetermined condition of the communication device, and a controller arranged to establish a first communication session over a telephone network through a telephone exchange between the first communication interface of the first communication device and a communication interface of another communication device, arranged to establish a second communication session through a telephone exchange from the second communication interface of the first communication device to the first communication interface of the first communication device, and arranged to, based upon the predetermined condition, establish a third communication session by connecting the first communication session and the second communication session such that the third communication session is established between the second communication interface of the first communication device and the communication interface of the another communication device.

The telephone network is preferably one of a cellular network and a POTS network. Before establishing the third communication session, the first communication session is preferably placed on hold. Establishing a third communication session is preferably performed by explicit call transfer. The predetermined condition is one or more of the following: magnitude of a signal strength of the first communication session, detection of a preferred network, quality of the first communication session, user generated command, and charge level of a battery.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is a diagram that illustrates an automatic hand-off between communication sessions that use VoIP in accordance with a preferred embodiment of the present invention.

FIG. 2 is a diagram that illustrates an automatic hand-off from a communication session that supports VoIP to a communication session that does not support VoIP in accordance with a preferred embodiment of the present invention.

FIG. 3 is a diagram that illustrates an automatic hand-off in a device that supports explicit call transfer in accordance with a preferred embodiment of the present invention.

FIG. 4 shows a mobile communication device in accordance with a preferred embodiment of the present invention.

### DETAILED DESCRIPTION OF PREFERRED EMBODIMENTS

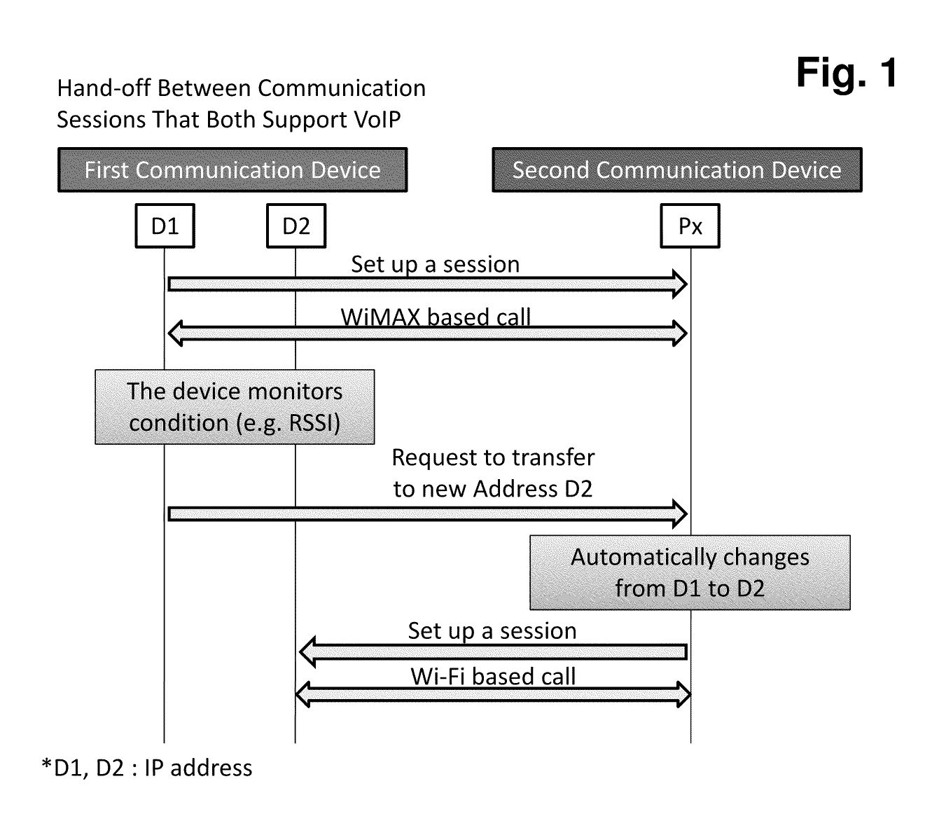

The preferred embodiments of the present invention are discussed below with respect to FIGS. 1-3. First, a description of connecting a communication device to a second communication device will be described. Then, various embodiments for performing hand-offs between the first and second communication devices under different conditions will be described. In the preferred embodiments of the present invention, hand-off decisions are made by the communication devices, without any need for a network-based controller to either gather information from the communication devices or make any hand-off decisions.

FIG. 1 shows a first communication device that includes communication interfaces D1, D2. The first communication device could be any suitable wireless mobile device, for example, a dual mode/multimode device such as WiMax+Voice over WLAN (VoWLAN), GSM+VoWLAN, WiMax+GSM, etc. The VoIP interface may be over a line interface instead of WIFI, e.g., FIOS, cable modem, Ethernet, etc. While only two communication interfaces D1, D2 are specifically described in the following preferred embodiments of the present invention, any desirable number of communication interfaces could be included. Each of the communication interfaces D1, D2 could be any one of, for example, a Wi-Fi interface, GSM interface, WiMax interface, G3 interface, or any other suitable protocol that allows IP communication. The first communication device can communicates with a second communication device through the communication interfaces D1, D2. The second communication device could be an IP telephone, the gateway of a VoIP service provider, or any other suitable device that has a communication interface that allows VoIP.

To establish a communication session, the first communication device selects one of the communication interfaces D1 or D2. In FIG. 1, the first communication interface D1 is used, but any communication interface can be used. The first communication interface D1 uses the IP address of the second communication device to set up the communication session between the first communication device and the second communication device. The IP address can be input in the first communication device by the user or can be from retrieved from the internal memory of the first communication device.

Once the communication session is established, the first communication device streams media to the second communication device. The endpoints D1, Px of the media stream are fixed. Any suitable media stream can be used, for example, RTP or SRTP streams over a VoIP network. In response, the second communication device can send a return media stream to the first communication interface D1 of the first communication device, which the second communication device received during the establishment of the first communication session. The second communication device preferably automatically switches from a first communication session to a second communication session over the same interface.

FIG. 1 shows an example of a preferred embodiment of the present invention in which the first communication interface D1 and second communication interface D2 of the first communication device and interface Px of the second communication device use VoIP. This example shows the hand-off from a WiMAX communication session on the first communication interface D1 to a Wi-Fi communication session on the second communication interface D2.

While the first communication session is active (i.e., as long as the first communication device and the second communication device are streaming media to each other), the first communication device monitors a desired condition. The monitored condition could be any combination of, for example, the signal strength of the connection between the first communication device and the second communication device (e.g. the received signal strength indication (RSSI) of the signal), the availability of a preferred network (e.g. detecting a Wi-Fi network), the quality of the communicated media, user generated (e.g., voice or manual) command, charge level of a battery, or any other suitable condition.

When the first communication device detects a change in the monitored condition, the first communication device initiates a hand-off from the communication session using the first communication interface D1 to the communication session using the second communication interface D2. This hand-off includes, for example, sending a session update message (e.g. a SIP re-INVITE message) in which the first communication device sends a new contact address (e.g. the address of the second communication interface D2) to the second communication device. Upon receiving the session update message, the second communication device automatically switches from the first communication interface D1 to the second communication interface D2. The switch from the first communication interface D1 to the second communication interface D2 is controlled by the first communication device, without the use of a network-based controller.

FIG. 1 shows an example of a preferred embodiment of the present invention in which the first communication interface D1 uses WiMAX and the second communication interface D2 uses Wi-Fi. In this preferred embodiment of the present invention, a first communication session over a WiMAX network (WiMAX call) is established between the first communication interface D1 of the first communication device and the communication interface Px of the second communication device. When the first communication device detects a drop in the RSSI of the WiMAX call below a predetermined threshold and detects the presence of a Wi-Fi network, the first communication device sends a SIP re-INVITE message through the first communication interface D1 to request the second communication device change from the first communication interface D1 to the second communication interface D2. The second communication device preferably drops the first communication session before switching to the second communication session.

Instead of using RSSI, it is also possible for the first communication device to detect a Wi-Fi signal above a predetermined threshold level. This could be useful, for example, in situations where the user of the first communication device has found a Wi-Fi hotspot and wishes to save money by using the cheaper Wi-Fi communications network. It is also possible for the first communication device to detect the availability of a preferred network, the quality of the communicated media, the existence of a user generated command, the charge level of a battery, or any other suitable condition.

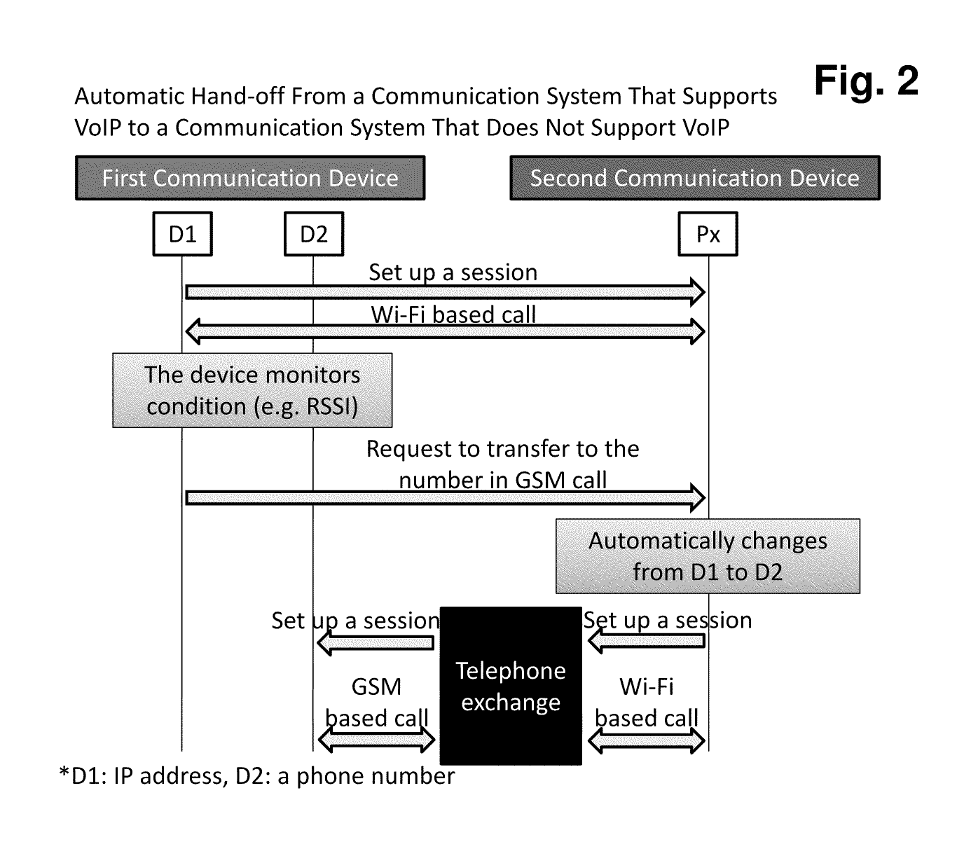

FIG. 2 shows an example of a preferred embodiment in which the first communication interface D1 supports VoIP and the second communication interface D2 does not support VoIP. This example shows the hand-off from a Wi-Fi communication session on the first communication interface D1 to a GSM communication session through a telephone exchange on the second communication interface D2.

While the first communication session is active, the first communication device is monitoring a desired condition. The monitored condition could be any combination of, for example, the signal strength of the connection between the first communication device and the second communication device (e.g. the received signal strength indication (RSSI) of the signal), the availability of a preferred network (e.g. detecting a Wi-Fi network), the quality of the communicated media, user generated (e.g., voice or manual) command, charge level of a battery, or any other suitable condition.

When the first communication device detects a change in the monitored condition, the first communication device initiates a hand-off from the communication session using the first communication interface D1 to the communication session using the second communication interface D2. This hand-off includes, for example, sending a session update message (e.g. a SIP REFER message) in which the first communication device requests the second communication device to transfer the session to a new contact address (e.g. the phone number of the second communication interface D2) to the second communication device. Upon receiving the session update message, the second communication device automatically switches from the first communication interface D1 to the second communication interface D2. The switch from the first communication interface D1 to the second communication interface D2 is controlled by the first communication device, without the use of a network-based controller.

FIG. 2 shows an example of a preferred embodiment of the present invention in which the first communication interface D1 uses Wi-Fi and the second communication interface D2 uses GSM. In this preferred embodiment of the present invention, a first communication session over a Wi-Fi network (Wi-Fi call) is established between the first communication interface D1 of the first communication device and the communication interface Px of the second communication device. When the first communication device detects a drop in the RSSI of the Wi-Fi call below a predetermined threshold and detects the presence of a GSM network, the first communication device sends a SIP REFER message through the first communication interface D1 to request the second communication device change from the first communication interface D1 to the second communication interface D2. The second communication device preferably drops the first communication session before switching to the second communication session.

Instead of using RSSI, it is also possible for the first communication device to detect a GSM signal above a predetermined threshold level.

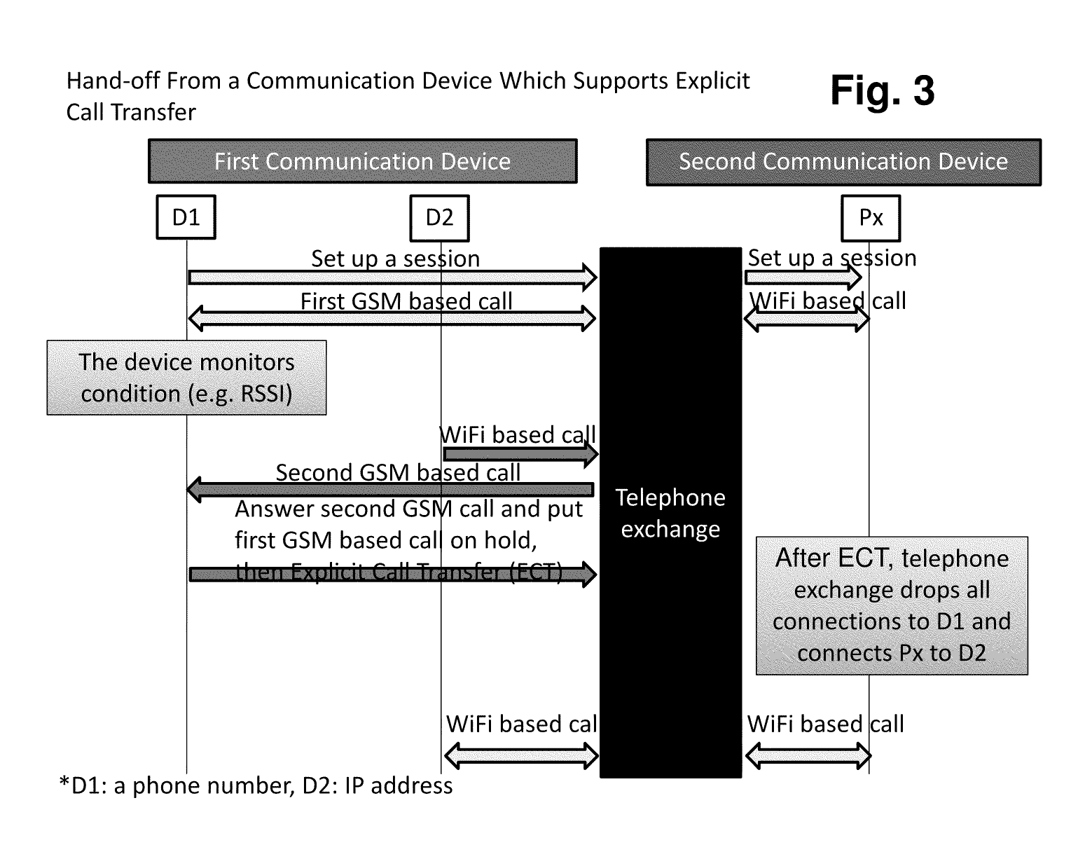

FIG. 3 shows another preferred embodiment of the present invention in which a first communication device supports explicit call transfer (ECT). ECT is provided on GSM networks and other similar networks. It is also possible to use other suitable networks that provide ECT or functions similar to ECT. For example, a network using plain old telephone service (POTS) can provide a call transfer function, which functions the same as ECT. ECT allows a device that has two calls from first and second callers to connect the two calls together such that a third call is established between the first and second callers and to release the device's connection to both the first and second callers. The first communication device of this preferred embodiment of the present invention uses ECT to hand-off communication sessions between the first communication interface D1 and the second communication interface D2. The first communication device performs a hand-off in which a first communication session has already been established between the first communication interface D1 and the communication interface Px over a GSM network through a telephone exchange by:

1) establishing a second communication session between the second communication interface D2 and the first communication interface D1 through a telephone exchange,

2) placing the first communication session on hold,

3) connecting the first communication session and the second communication session with ECT such that a third communication session is established between the second communication interface D2 and the communication interface Px, and

4) dropping the first communication session and the second communication session.

The operation can also be performed by first placing the first communication session on hold, then establishing a second communication session from the first communication interface D1 to the second communication interface D2 through a telephone exchange, then perform ECT such that a third communication session is established between the second communication interface D2 and the communication interface Px, and dropping the first communication session and the second communication session. This hand-off is controlled by the first communication device, using standard telephony service provided by the network, without the use of a network-based hand-off controller.

FIG. 3 shows an example of a preferred embodiment of the present invention in which the first communication interface D1 uses GSM and the second communication interface D2 uses Wi-Fi. In this preferred embodiment of the present invention, a first communication session over a GSM network through a telephone exchange (Wi-Fi call) is established between the first communication interface D1 of the first communication device and the communication interface Px of the second communication device. In this preferred embodiment of the present invention, the Wi-Fi call is connected between the first communication interface D1 and the communication interface Px through a telephone exchange (which is necessary to connect a Wi-Fi terminal with a GSM terminal). When the first communication device detects the presence of a Wi-Fi network, the first communication device calls the first communication interface D1 from the second communication interface D2 though the telephone exchange. The first communication interface D1 answers the call from the second communication interface D2 while placing on hold the active call between the first communication interface D1 and the communication interface Px, and then initiates an ECT among the first communication interface D1, the second communication interface D2, and the communication interface Px. Upon successful execution of an ECT, the telephone exchange establishes a new communication session between the second communication interface D2 of the first communication device and interface Px of the second communication device and disconnects the first communication session between the first communication interface D1 and the interface Px and the second communication session between the first communication interface D1 and the second communication interface D2.

Instead of using RSSI, it is also possible for the first communication device to detect a Wi-Fi signal above a predetermined threshold level. This could be useful, for example, in situations where the user of the first communication device has found a Wi-Fi hotspot and wishes to save money by using the cheaper Wi-Fi communications network. It is also possible for the first communication device to detect the availability of a preferred network, the quality of the communicated media, the existence of a user generated command, the charge level of a battery, or any other suitable condition.

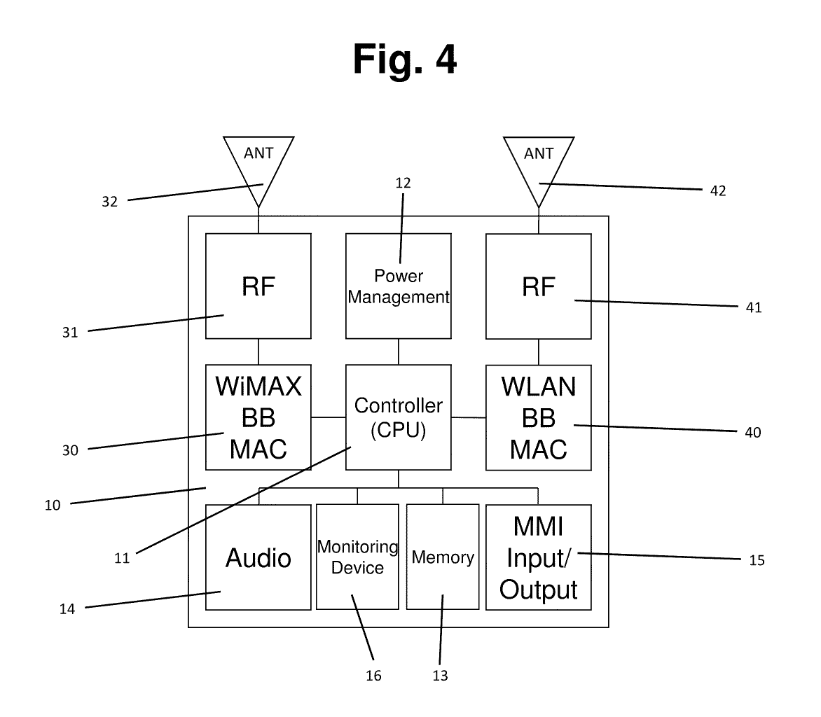

FIG. 4 shows an example of a communication device 10 according to a preferred embodiment of the present invention. In the example shown in FIG. 4, the communication device 10 is able to communicate over WiMAX and WLAN networks. The communication device 10 includes a controller 11, which is typically a central processing unit (CPU), that is programmed to control the various functions of the communication device 10, including the hand-offs methods of the preferred embodiments of the present invention discussed above. The controller 11 is connected to a power management module 12 that provides power for the communication device 10 and includes, for example, a battery. The controller 11 is also connected to memory module 13 that provides electronic information storage for the communication device 10. The controller 11 is also connected to input/output modules, including, for example, audio module 14 and man-to-machine-interface (MMI) input/output module 15. The controller is also connected to a monitoring device 16 that monitors one or more of the RSSI of the communication sessions, the availability of a preferred network, the quality of the communicated media, the existence of a user generated command, the charge level of a battery, or any other suitable condition.

The communication device 10 also includes a WiMAX wireless radio that enables the communication device 10 to communicate over a WiMAX network and a WLAN wireless radio that enables the communication device 10 to communicate over WLAN network. The WiMAX wireless radio includes a WiMAX baseband (BB) and medium access control (MAC) module 30 that is connected to an antenna 32 through an RF module 31. The WLAN wireless radio includes a baseband (BB) and medium access control (MAC) module 40 that is connected to an antenna 42 through an RF module 41. Both the WiMAX BB MAC module 30 and the WLAN BB MAC module 40 are connected to the controller 11.

The above preferred embodiments of the present invention describe hand-off methods that can be implemented over the existing cellular, WiMax, and Wi-Fi networks without requiring any change in existing network elements. The preferred embodiments of the present invention also support hand-offs between different communication sessions using different media protocols and different service providers, even if there is no existing roaming agreement between the different service providers. Further, by using preferred embodiments of the present invention, wireless mobile device vendors have much more freedom to design innovative hand-off decision algorithms because the hand-off decision is completed controlled by the communication device.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A communication session hand-off method of a communication device comprising:
establishing a first communication session over a first network between a first communication interface of the communication device and a communication interface of another communication device;
monitoring a predetermined condition of the communication device by the communication device; and
based upon the predetermined condition, sending a request by the communication device to the another communication device for the another communication device to establish a second communication session over a second network between a second communication interface of the communication device and the communication interface of the another communication device.

2. A method according to claim 1, wherein the another communication device is an IP telephone.

3. A method according to claim 1, wherein:
the first network is one of a cellular network, a POTS network, and an IP based network; and
the second network is one of a cellular network, a POTS network, and an IP based network.

4. A method according to claim 1, wherein the predetermined condition is one or more of the following:
magnitude of a signal strength of the first communication session;
detection of a preferred network;
quality of the first communication session;
user generated command; and
charge level of a battery.

5. A communication session hand-off method of a communication device comprising:
establishing a first communication session over a telephone network through a telephone exchange between a first communication interface of the communication device and a communication interface of another communication device;
establishing a second communication session through a telephone exchange from a second communication interface of the first communication device to the first communication interface of the first communication device;
monitoring a predetermined condition; and
based upon the predetermined condition, establishing a third communication session by connecting the first communication session and the second communication session such that the third communication session is established between the second communication interface of the first communication device and the communication interface of the another communication device.

6. A method according to claim 5, wherein the another communication device is an IP telephone.

7. A method according to claim 5, wherein the telephone network is one of a cellular network and POTS network.

8. A method according to claim 5, wherein, before the step of establishing the third communication session, the first communication session is placed on hold.

9. A method according to claim 5, wherein the step of establishing a third communication session is performed by explicit call transfer.

10. A method according to claim 5, wherein the predetermined condition is one or more of the following:
magnitude of a signal strength of the first communication session;
detection of a preferred network;
quality of the first communication session;
user generated command; and
charge level of a battery.

11. A communication device comprising:
a first communication interface;
a second communication interface;
a monitoring device arranged to monitor a predetermined condition of the communication device; and
a controller arranged to:
establish a first communication session over a first network between the first communication interface of the first communication device and a communication interface of another communication device; and
based upon the predetermined condition, send a request by the communication device to the another communication device for the another communication device to establish a second communication session over a second network between the second communication interface of the communication device and the communication interface of the another communication device.

12. A communication device according to claim 11, wherein:
the first network is one of a cellular network, a POTS network, and an IP based network; and
the second network is one of a cellular network, a POTS network, and an IP based network.

13. A communication device according to claim 11, wherein the predetermined condition is one or more of the following:
magnitude of a signal strength of the first communication session;
detection of a preferred network;
quality of the first communication session;
user generated command; and
charge level of a battery.

14. A communication device comprising:
a first communication interface;
a second communication interface;
a monitoring device arranged to monitor a predetermined condition of the communication device; and
a controller arranged to:
establish a first communication session over a telephone network through a telephone exchange between the first communication interface of the first communication device and a communication interface of another communication device;
establish a second communication session through a telephone exchange from the second communication interface of the first communication device to the first communication interface of the first communication device; and
based upon the predetermined condition, establish a third communication session by connecting the first communication session and the second communication session such that the third communication session is established between the second communication interface of the first communication device and the communication interface of the another communication device.

15. A communication device according to claim 14, wherein the telephone network is one of a cellular network and a POTS network.

16. A communication device according to claim 14, wherein, before establishing the third communication session, the first communication session is placed on hold.

17. A communication device according to claim 14, wherein establishing a third communication session is performed by explicit call transfer.

18. A communication device according to claim 14, wherein the predetermined condition is one or more of the following:
magnitude of a signal strength of the first communication session;
detection of a preferred network;
quality of the first communication session;
user generated command; and
charge level of a battery.
